(19) United States
(12) Patent Application Publication
(10) Pub. No.: US 2010/0104074 A1
(43) Pub. Date: Apr. 29, 2010

(54) Call recording method and communication system

(75) Inventor: Yu-Chun Yang, Luzhou City (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 12/453,305

(22) Filed: May 6, 2009

(30) Foreign Application Priority Data
Oct. 24, 2008 (TW) 097141013

(51) Int. Cl. H04M 11/00; H04M 1/64; H04L 12/66

(52) U.S. Cl. 379/88.13; 379/88.25; 370/352

(57) ABSTRACT

The invention discloses a call recording method, including the steps of: (a) setting a call recording extension in a first terminal; (b) dialing the first terminal via the call recording extension from the first terminal to communicate with a server when a phone call is established between the first terminal and a second terminal; (c) activating a three-way conference; and (d) recording the content of the phone call between the first terminal and the second terminal into the server by use of the three-way conference.

### BACKGROUND OF THE INVENTION

1. Field of the Invention

The present invention relates to a call recording; and more particularly, to a call recording suitable for a communication system.

2. Description of the Prior Art

As every body knows, the call recording function allows a user to record the content of the phone call and take action to access the recorded content of the phone call. At present, for the Private Branch Exchange (PBX) system, suitable settings are needed to achieve the recording function. Moreover, the recording settings of telephones corresponding to different PBX servers are not all the same, and it is especially complicated regarding the internet protocol private branch exchange system.

Because the communication data between the terminals of the IP-PBX system is transmitted by a form of network packets, it is difficult to intercept and reorganize the network packets in technique, which needs very complicated recording system accompanying with special network settings. However, if the network packets have been encrypted, it is almost impossible to reorganize the network packets. In addition, if the IP-PBX system communicates with a terminal outside the network thereof by analog circuits, a recording apparatus can be set in the way of the analog circuits. However, if the IP-PBX system communicates with the terminal outside the network by network, the difficulty of recording is as aforementioned.

Currently, certain telephones are equipped with digital recorders, so the telephones can carry on the recording without the support of PBX server. However, the storage capacity of each such telephone has its restriction, not like the PBX system having a huge storage capacity. Hence, the recording time and the number of phone call are very restricted in such phones.

Therefore, a major scope of the invention is to provide a call recording method suitable for a communication system to solve the above mentioned problem.

### SUMMARY OF THE INVENTION

An aspect of the present invention is to provide a call recording method. According to an embodiment of the invention, the call recording method comprises the following steps.

Firstly, a call recording extension is set in a first terminal. When a phone call is established between the first terminal and a second terminal, the first terminal dials to the first terminal via the call recording extension to communicate with a server. Next, a three-way conference is activated. Afterwards, the content of the phone call between the first terminal and the second terminal is recorded into the server by use of the three-way conference.

Another aspect of the present invention is to provide a communication system. According to another embodiment of the invention, the communication system comprises a server, a first terminal and a second terminal.

The server comprises a data base. The first terminal has a call recording extension set in it. When a phone call is established between the first terminal and the second terminal, the first terminal dials to the first terminal via the call recording extension to communicate with the server and to activate a three-way conference, and then the content of the phone call between the first terminal and the second terminal is recorded into the data base of the server.

The advantage and spirit of the invention may be understood by the following recitations together with the appended drawings.

### BRIEF DESCRIPTION OF THE APPENDED DRAWINGS

FIG. 1 is a functional block diagram illustrating a communication system according to an embodiment of the invention.

FIG. 2 is the transmission direction of the audio frequency signal during the three-way conference.

FIG. 3 is a functional block diagram illustrating a communication system according to another embodiment of the invention.

FIG. 4 is a flow chart illustrating the call recording method according to another embodiment of the invention.

### DETAILED DESCRIPTION OF THE INVENTION

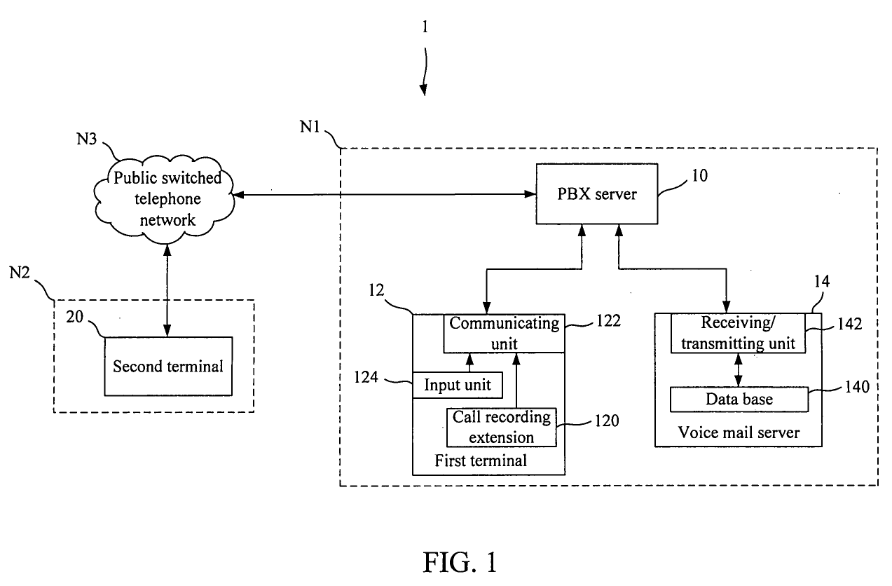

In order to sufficiently understand the concept of the invention, embodiments and their related figures are listed in the following for detailed descriptions. Please refer to FIG. 1. FIG. 1 is a functional block diagram illustrating a communication system 1 according to an embodiment of the invention.

As shown in FIG. 1, the communication system 1 comprises a PBX server 10, a first terminal 12, a second terminal 20 and a voice mail server 14. Please note that the communication system 1 may comprise a plurality of terminals and is not limited to the first terminal 12. Moreover, besides existing independently (as shown in FIG. 1), the voice mail server 14 may also be contained in the PBX server 10. In practice, the PBX server 10 can be an Internet Protocol Private Branch Exchange (IP-PBX). And, the communication system 1 according to the invention can be applied to a Session Initiation Protocol (SIP).

In practice, the first terminal 12 and the voice mail server 14 communicate with each other via a first network N1, for example, a Local Area Network (LAN), and through the PBX server 10. But, the communication is not limited to LAN. The second terminal 20 is outside the first network N1 and is located in a second network N2. The second terminal 20 is communicated with the first terminal 12 via, for example, a Public Switched Telephone Network (PSTN) N3.

As shown in FIG. 1, the first terminal 12 has a call recording extension 120 therein and comprises a communication unit 122. In practice, the first terminal 12 may be connected to an external electronic apparatus (e.g. a computer) and the call recording extension 120 in the first terminal 12 is setup via an application program. The communicating unit 122 is for connecting to apparatuses of the communication system 1, for example, the second terminal 20 and the server. It is emphasized that the first terminal 12 according to the invention has the function of three-way conference. In addition, the call recording extension 120 is standard for the PBX server 10, i.e. the first terminal 12 does not need the PBX server 10 to provide special support. The voice mail server 14 comprises a data base 140.

When a phone call is established between the first terminal 12 and the second terminal 20, the user of the first terminal 12 can dial to the first terminal itself via the call recording extension 120 if the user wants to start recording the content of the phone call at any time during the period of the phone call. Because the first terminal 12 is communicated with the second terminal 20, the first terminal 12 transfers the incoming call dialed via the call recording extension 120 to the voice mail server 14, i.e. the voice mail server 14 is communicated via the communicating unit 122 and the three-way conference is activated.

In practice, the first terminal 12 may comprise an input unit 124 (for example, a key switch) coupled to the communicating unit 122. When the user presses the input unit 124 during the phone call of the first terminal 12, the communicating unit 122 will make the phone call via the call recording extension 120 in response to the user's operation.

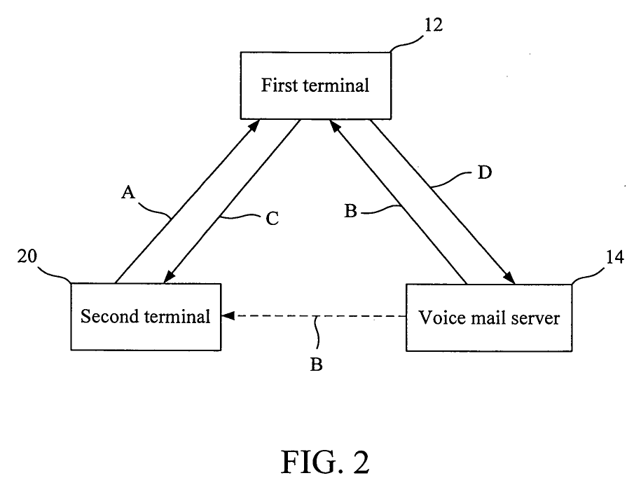

Please refer to FIG. 2. FIG. 2 is the transmission directions of the audio frequency signals during the three-way conference. After the three-way conference is activated, the first terminal 12 receives a first audio frequency signal A from the second terminal 20 and a second audio frequency signal B from the voice mail server 14. For example, the first audio frequency signal A is the voice of the user of the second terminal 20, and the second audio frequency signal B is a message of “greeting” or “goodbye” sent out from the voice mail server 14. The second terminal 20 receives a third audio frequency signal C (for example, the voice of the user of the first terminal 12) from the first terminal 12 and the second audio frequency signal B from the voice mail server 14. However, in practice, if the message from the voice mail server 14 is not desirable to be heard by the user of the second terminal 20, the three-way conference can be modified to make the second terminal 20 receive the third audio frequency signal C from the first terminal 12 merely. Besides, the voice mail server 14 receives a fourth audio frequency signal D comprising the third audio frequency signal C from the first terminal 12 and the first audio frequency signal A from the second terminal 20.

It is known from the above explanations that, by use of the three-way conference of the first terminal 12, the content of the phone call between the first terminal 12 and the second terminal 20 can be recorded into the data base 140 of the voice mail server 14. In addition, the voice mail server 14 also comprises a receiving/transmitting unit 142 coupled to the data base 140.

After the content of the phone call between the first terminal 12 and the second terminal 20 is stored into the data base 140 of the voice mail server 14, the user may access the recorded content of the phone call directly via any terminal connected to the receiving/transmitting unit 142. Or, the voice mail server 14 may send the recorded content of the phone call in a form of an e-mail's attached file to the user for reading.

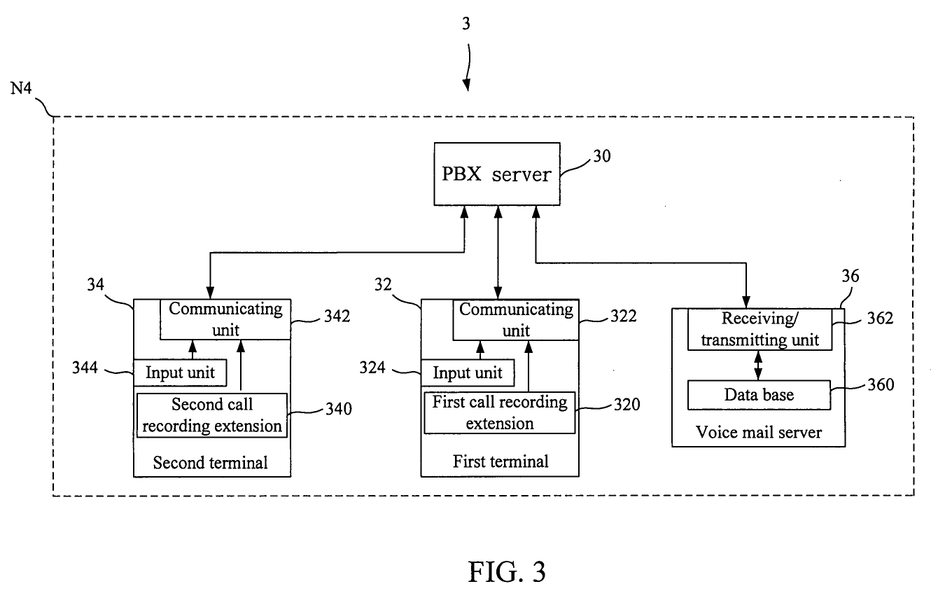

Please refer to FIG. 3. FIG. 3 is a functional block diagram illustrating a communication system 3 according to another embodiment of the invention.

The communication system 3 comprises a PBX server 30, a first terminal 32, a second terminal 34 and a voice mail server 36. In the embodiment, the first terminal 32, the second terminal 34 and the voice mail server 36 are located in the same network N4, for example, a local area network, and communicate with each other via the PBX server 30.

As shown in FIG. 3, the first terminal 32 and the second terminal 34 have a first call recording extension 320 and a second call recording extension 340 therein respectively. It is emphasized that both the first terminal 32 and the second terminal 34 have the function of three-way conference.

Therefore, when the user of the first terminal 32 dials to the second terminal 34, the user of the second terminal 34 can dial to the second terminal 34 itself via the second call recording extension 340 if the user of the second terminal 34 wants to start recording the content of the phone call at any time during the period of the phone call. And then, the voice mail server 36 is communicated and the three-way conference is activated. Thereby, the content of the phone call is recorded into the data base 360 of the voice mail server 36. Similarly, after the user of the second terminal 34 dials to the first terminal 32, the user of the first terminal 32 also can achieve the recording furntion via the first call recording extension 320.

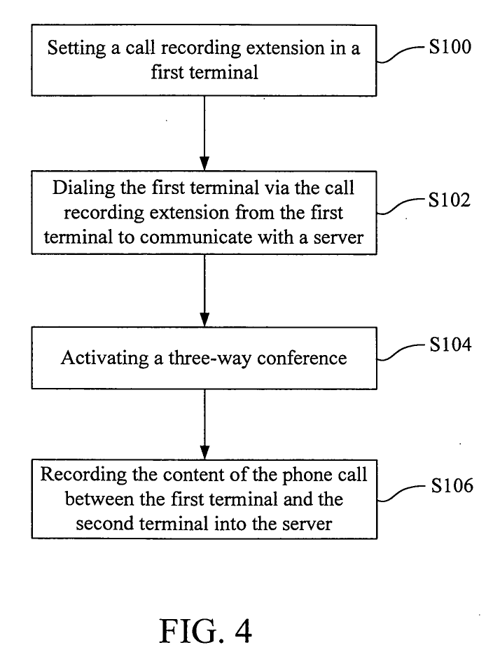

Please refer to FIG. 4. FIG. 4 is a flow chart illustrating the call recording method according to another embodiment of the invention. In practice, the call recording method according to the invention can be performed in an IP-PBX system. In addition, the IP-PBX system may apply a session initiation protocol.

Firstly, in step S100, a call recording extension is set in a first terminal.

When a phone call is established between the first terminal and a second terminal, step S102 is performed to dial to the first terminal via the call recording extension from the first terminal to communicate with a server. Please note that the first terminal and the second terminal can be in the same network or different networks.

Next, in step S104, a three-way conference is activated.

Afterwards, the content of the phone call between the first terminal and the second terminal is recorded into the server by use of the three-way conference.

To sum up, the call recording method of the invention may set up the call recording extension in the terminal of the communication system, and record the content of the phone call of the terminal via the three-way conference. No matter the terminals are in the same network or different networks, the phone call between the terminals can be recorded according to this invention. Besides, because said call recording extension is standard for the PBX server, the call recording method of the invention does not need the special support of the PBX server or additional complicated recording systems.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A call recording method comprising the steps of:
(a) setting a call recording extension in a first terminal;
(b) dialing to the first terminal via the call recording extension from the first terminal to communicate with a server when a phone call is established between the first terminal and a second terminal;
(c) activating a three-way conference; and
(d) recording the content of the phone call between the first terminal and the second terminal into the server by use of the three-way conference.

2. The call recording method of claim 1, further comprising the step of:
(e) communicating with the server to access the recorded content of the phone call directly.

3. The call recording method of claim 1, further comprising the step of:
(f) sending the recorded content of the phone call in a form of an e-mail via the server.

4. The call recording method of claim 1, wherein the first terminal receives a first audio frequency signal from the second terminal and a second audio frequency signal from the server after the three-way conference is activated; the second terminal receives a third audio frequency signal from the first terminal; the server receives the third audio frequency signal from the first terminal and the first audio frequency signal from the second terminal.

5. The call recording method of claim 1, wherein the first terminal and the second terminal are in the same network.

6. The call recording method of claim 1, wherein the first terminal is in a first network and the second terminal is in a second network.

7. The call recording method of claim 1, wherein the call recording method is performed in a system applying a session initiation protocol.

8. The call recording method of claim 1, wherein the call recording method is performed in an internet protocol private branch exchange system.

9. The call recording method of claim 1, wherein the server is a voice mail server.

10. A communication system comprising:
a server comprising a data base;
a first terminal having a call recording extension therein; and
a second terminal, when a phone call is established between the first terminal and the second terminal, the first terminal dialing to the first terminal via the call recording extension to communicate with the server and to activate a three-way conference, and then the content of the phone call between the first terminal and the second terminal being recorded into the data base of the server.

11. The communication system of claim 10, wherein the first terminal also comprises:
an input unit for making the first terminal dial via the call recording extension in response to a user's operation.

12. The communication system of claim 10, wherein the server also comprises:
a receiving/transmitting unit coupled to the data base, a terminal is capable of being connected to the receiving/transmitting unit to access the recorded content of the phone call directly.

13. The communication system of claim 10, wherein the server also comprises:
a receiving/transmitting unit, coupled to the data base, for sending the recorded content of the phone call in a form of an e-mail.

14. The communication system of claim 10, wherein the first terminal receives a first audio frequency signal from the second terminal and a second audio frequency signal from the server after the three-way conference is activated; the second terminal receives a third audio frequency signal from the first terminal; the server receives the third audio frequency signal from the first terminal and the first audio frequency signal from the second terminal.

15. The communication system of claim 10, wherein the first terminal and the second terminal are in the same network.

16. The communication system of claim 10, wherein the first terminal is in a first network and the second terminal is in a second network.

17. The communication system of claim 10, wherein the communication system is applied to a session initiation protocol.

18. The communication system of claim 10, wherein the communication system also comprises an internet protocol private branch exchange server for making the first terminal and the server communicated with each other.

19. The communication system of claim 10, wherein the server is a voice mail server.
